(19) United States
(12) Patent Application Publication
(10) Pub. No.: US 2020/0118131 A1
(43) Pub. Date: Apr. 16, 2020

(54) DATABASE TRANSACTION COMPLIANCE

(71) Applicant: International Business Machines Corporation, Armonk, NY (US)

(72) Inventors: Abdigani Diriye, NAIROBI (KE); Komminist Weldemariam, Nairobi (KE); Kumar Bhaskaran, YORKTOWN HEIGHTS, NY (US); Clifford A. Pickover, YORKTOWN HEIGHTS, NY (US)

(21) Appl. No.: 16/157,847

(22) Filed: Oct. 11, 2018

(51) Int. Cl. G06Q 20/40; G06F 17/30; G06Q 20/06

(52) U.S. Cl. CPC G06Q 20/4016; G06F 17/30377; H04L 9/0637; H04L 2209/38; G06Q 20/06

(57) ABSTRACT

An example operation may include one or more of receiving, by a blockchain node, a request to transfer an asset, generating a blockchain transaction, obtaining one or more rules from a smart contract corresponding to a smart contract identifier, and comparing one or more parameters to the one or more rules to obtain a risk level. In response to the risk level being greater than a threshold, the example operation includes not executing the blockchain transaction. In response to the risk level not being greater than the threshold, the example operation includes executing the transaction. The request includes the smart contract identifier and the one or more parameters. The asset includes one of a trade item or a service to be performed. The blockchain transaction includes the smart contract identifier and the one or more parameters.

### TECHNICAL FIELD

This application generally relates to a database storage system, and more particularly, to database transaction compliance.

### BACKGROUND

A centralized database stores and maintains data in one single database (e.g., database server) at one location. This location is often a central computer, for example, a desktop central processing unit (CPU), a server CPU, or a mainframe computer. Information stored on a centralized database is typically accessible from multiple different points. Multiple users or client workstations can work simultaneously on the centralized database, for example, based on a client/server configuration. A centralized database is easy to manage, maintain, and control, especially for purposes of security because of its single location. Within a centralized database, data redundancy is minimized as a single storing place of all data also implies that a given set of data only has one primary record.

However, a centralized database suffers from significant drawbacks. For example, a centralized database has a single point of failure. In particular, if there are no fault-tolerance considerations and a hardware failure occurs (for example a hardware, firmware, and/or a software failure), all data within the database is lost and work of all users is interrupted. In addition, centralized databases are highly dependent on network connectivity. As a result, the slower the connection, the amount of time needed for each database access is increased. Another drawback is the occurrence of bottlenecks when a centralized database experiences high traffic due to a single location. Furthermore, a centralized database provides limited access to data because only one copy of the data is maintained by the database. As a result, multiple devices cannot access the same piece of data at the same time without creating significant problems or risk overwriting stored data. Furthermore, because a database storage system has minimal to no data redundancy, data that is unexpectedly lost is very difficult to retrieve other than through manual operation from back-up storage.

Conventionally, a centralized database is limited by an inability to maintain transaction compliance with smart contracts. As such, what is needed is a solution to overcome these significant drawbacks.

### SUMMARY

One example embodiment provides a system that includes a blockchain network, which includes first and second blockchain nodes. The first blockchain node is configured to receive a request to transfer an asset, and generate a blockchain transaction including a smart contract identifier and one or more parameters. The second blockchain node is configured to obtain one or more rules from a smart contract that corresponds to the smart contract identifier and compare the one or more parameters to the one or more rules to obtain a risk level. In response to the risk level is greater than a threshold, the second blockchain node is configured to not execute the blockchain transaction. In response to the risk level is not greater than the threshold, the second blockchain node is configured to execute the transaction. The request includes the smart contract identifier and the one or more parameters. The asset includes one of a trade item or a service to be performed.

Another example embodiment provides a method that includes one or more of receiving, by a blockchain node, a request to transfer an asset, generating a blockchain transaction, obtaining one or more rules from a smart contract corresponding to a smart contract identifier, and comparing one or more parameters to the one or more rules to obtain a risk level. In response to the risk level being greater than a threshold, the example operation includes not executing the blockchain transaction. In response to the risk level not being greater than the threshold, the example operation includes executing the transaction. The request includes the smart contract identifier and the one or more parameters. The asset includes one of a trade item or a service to be performed. The blockchain transaction includes the smart contract identifier and the one or more parameters.

A further example embodiment provides a non-transitory computer readable medium including instructions, that when read by a processor, cause the processor to perform one or more of receiving, by a blockchain node, a request to transfer an asset, generating a blockchain transaction, obtaining one or more rules from a smart contract corresponding to a smart contract identifier, and comparing one or more parameters to the one or more rules to obtain a risk level. In response to the risk level being greater than a threshold, the example operation includes not executing the blockchain transaction. In response to the risk level not being greater than the threshold, the example operation includes executing the transaction. The request includes the smart contract identifier and the one or more parameters. The asset includes one of a trade item or a service to be performed. The blockchain transaction includes the smart contract identifier and the one or more parameters.

### BRIEF DESCRIPTION OF THE DRAWINGS

FIG. 1 illustrates a network diagram of a system including a database, according to example embodiments.

FIG. 2A illustrates an example peer node configuration, according to example embodiments.

FIG. 2B illustrates a further peer node configuration, according to example embodiments.

FIG. 3 illustrates a permissioned network, according to example embodiments.

FIG. 4 illustrates a system messaging diagram for performing an asset transfer transaction, according to example embodiments.

FIG. 5A illustrates a flow diagram for performing an asset transfer transaction, according to example embodiments.

FIG. 5B illustrates a flow diagram of a method of managing a smart contract in a blockchain, according to example embodiments.

FIG. 6A illustrates an example system configured to perform one or more operations described herein, according to example embodiments.

FIG. 6B illustrates a further example system configured to perform one or more operations described herein, according to example embodiments.

FIG. 6C illustrates a smart contract configuration among contracting parties and a mediating server configured to enforce the smart contract terms on the blockchain according to example embodiments.

FIG. 6D illustrates another an additional example system, according to example embodiments.

FIG. 7A illustrates a process of new data being added to a database, according to example embodiments.

FIG. 7B illustrates contents a data block including the new data, according to example embodiments.

FIG. 8 illustrates an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, components, non-transitory computer readable media, devices, and/or networks, which provide compliance for blockchain transactions.

A decentralized database is a distributed storage system which includes multiple nodes that communicate with each other. A blockchain is an example of a decentralized database which includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency. In a public or permission-less blockchain, anyone can participate without a specific identity. Public blockchains often involve native cryptocurrency and use consensus based on various protocols such as Proof of Work (PoW). On the other hand, a permissioned blockchain database provides a system which can secure inter-actions among a group of entities which share a common goal but which do not fully trust one another, such as businesses that exchange funds, goods, information, and the like.

A blockchain operates arbitrary, programmable logic, tailored to a decentralized storage scheme and referred to as “smart contracts” or “chaincodes.” In some cases, specialized chaincodes may exist for management functions and parameters which are referred to as system chaincode. Smart contracts are trusted distributed applications which leverage tamper-proof properties of the blockchain database and an underlying agreement between nodes which is referred to as an endorsement or endorsement policy. In general, blockchain transactions typically must be “endorsed” before being committed to the blockchain while transactions which are not endorsed are disregarded. A typical endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

A ledger is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain. There is typically one ledger per channel. Each peer node maintains a copy of the ledger for each channel of which they are a member.

A chain is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Some benefits of the instant solutions described and depicted herein include creating, facilitating and managing norms/compliant transactions associated with the transfer of an asset via smart contracts and blockchain technology, where the smart contracts may in some embodiments be driven from specific norms. The instant solutions include a means for monitoring transactions that use smart contracts, a means for determining that a risk or concern level of the asset transactions are non compliant with a set of first rules with a confidence-level L, and, based on detected risk or concern, a system may take an amelioration action (e.g., providing a graphical indication of one or more dimensions of risk on a smart phone, preventing a transaction, a requiring of a specific approval, automatic forcing/suggesting of an online attempted transaction to a compliant online or in-store asset transaction, triggering an automated virtual reality (VR) session to explain/educate with respect to possible concerns, providing a tactile indication of one or more dimensions of risk such as a using a vibration on a smart phone, etc).

Blockchain is different from a traditional database in that blockchain is not a central storage but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the creating, facilitating and managing norms/compliant asset transactions via smart contracts and blockchain technology is implemented due to immutability/accountability, smart contracts, security, decentralized/distributed transactions, consensus, endorsement, and accessibility, which are inherent and unique to blockchain. In particular, with respect to immutability/accountability, the present application creates a permanent and unbreakable link between a building identifier, a sensor identifier, service records related to a sensor and a problem (e.g., sensor software, hardware, connectivity, or service) and the sensor itself. That link—the record of “ownership”—can be forever verified and tracked.

With respect to smart contracts, various smart contracts may be generated from various rules and conditions that govern how to process, manage, and store transactions. In the context of this invention, when applicable, some of these contracts (rules and conditions) are translated/encoded as smart contracts (programmed as chaincodes). Some other contracts may be translated/encoded as simple control logic implemented outside of blockchain (e.g., in client applications).

One of the benefits of the example embodiments is that it improves the functionality of a computing system by enabling an automated means for creating asset transfer contracts and computing/monitoring the transactions and financial contracts for risk of non-compliance. This approach allows risk to be detected prior to execution and continuously store this enabling a more robust way to identify non-compliance and enable a trusted and verified data point for the transaction, transaction history, and compliance of stakeholders.

Through the blockchain system described herein, a computing system can perform auditability and transparency functions. Specifically, it would be difficult to establish a digital and verifiable trust among stakeholders involved in a given transaction in a decentralized/distributed manner. Moreover, the features of smart contracts would require the blockchain technology and smart contract to fully express the business rules.

The example embodiments provide numerous benefits over a traditional database. For example, through the blockchain the embodiments provide creating, facilitating, and managing compliant asset transactions via smart contracts and blockchain technology.

Meanwhile, if a traditional database were used to implement the example embodiments, the example embodiments would suffer from unnecessary drawbacks such as an inability to assess risks associated with asset transactions and either eliminate, delay, or ameliorate the transaction if the risks remain unaddressed. Accordingly, the example embodiments provide for a specific solution to a problem in the arts/field of blockchain transaction qualification. The present application creates a functional improvement by enabling asset-related contracts via blockchains, and alters through time or assessment of risks relating to compliance, a series of blocks. The rate of addition to the blockchain may be increased if risk or a concern level is judged to be high (e.g., to have a more granular record when deemed useful), and the content added to the block may change based on risk level and other factors. This allows improved detection of compliance and monitoring transactions associated with asset-related contracts and determining or predicting risk or concern level.

The example embodiments also change how data may be stored within a block structure of the blockchain. For example, amelioration action data may be stored within new data blocks. By storing risk scores and dimensions of the transactions, amelioration steps taken and content presented, and type of content provided (e.g. video, text, etc.) within data blocks of a blockchain, the amelioration action data may be appended to an immutable ledger through a hash-linked chain of blocks. The stored data may also include contextual Factors, such as location(s) of transactions, one or more compliance levels, and a user cohort or association that a user involved with the asset transaction may be part of.

Examples herein describe use cases with respect to various requests and transactions, but it should be understood the present application applies to any such environment or situation, which may include concerns relevant to tradition, heritage, ethical principles, environmental stewardship, and/or customs concerning food source, food transport, and food preparation.

To summarize, the business challenges associated with banking include high operational costs for asset financing and lending, suboptimal contract decisions, and a lack of personalized/customized financial offerings to suit customer profiles. The present invention reduces these challenges by identifying the right smart contract, terms, conditions, costs, and fees (individuals and businesses have different contexts which might make one contract better suited than another), uses historic performance of past contract and loans for individuals and businesses we can create a more optimized process, helps the banks select better financing option, simulates the effects on its balance sheet and P&L, provides an easy-to-use interface for a user that relates to dimensions of risk, feedback, education, and more.

Note that aspects of banking and finance revolve around requirements such as avoidance of prohibitions and ensuring that the contracts have all their essential elements with their necessary conditions. Financial contracts are based on analyzing the need for financing request of an individual or a retail or business customer. The method may dynamically determine an appropriate contract to use from a plurality of smart contracts, the terms of the contract for the given financial product from a financing request, and trade-off risk/reward. The system may use various configurations of contracts for requested financial products, and the configurations may be based on user-specified constraints and context specifications. In one embodiment, the system may dynamically configure parameters of a contract such as a duration or a ratio of risk sharing etc. In some sense, the system may learn what contract configurations to apply or compose for an individual or business, including analyzing characteristics or properties of the requested contract by analyzing the historical configurations of similar contracts and analyzing context information (e.g., including a location the contract is to be used at) using one or more trained machine learning models (e.g., using Decision Trees, Adaboost, Support Vector Machines, etc.).

The system and method for financial contracts creation may use various objective or optimization algorithms based on user cohort and context so as to personalize/customize the financial offerings to intend uses. In fact, over time the system may curate the contract data as well as related performance and use this source to learn and recommend contracts that have lower risk based on optimization considerations.

The system and method may be configured to monitor and collect transactions associated with generated financial contracts for the financial requests. The monitoring and collecting of transactions associated with the generated financial contract may be performed on a plurality of devices, such as on cross-vender ecommerce platforms, Point of Sale (POS) devices, cross-vendor payment systems/devices (e.g. mobile money such as MPESA), or in-vehicle sensory devices, etc.

In other embodiments, the present application discloses a method of trans-vendor monitoring or tracking service (e.g. online stores such as e-Bay, Amazon, Walmart.com, local hardware store) for detecting items or ingredients (e.g. purchasing or browsing). A monitoring or collecting module may automatically consider transactions/materials purchased so far, and then predicts the likelihood of buying the next material M is related to one or more prohibited lists of items or ingredients. The method and system for tracking transactions associated with contracts may be used to create prohibited lists of items/transactions database with risk levels and other contextual factors including a location, the transacting parties, types of transactions, commodities/assets associated with the transactions, credit scores or financial histories of the transaction parties, etc. Thus, the system may use a database to detect or predict patterns from collected transactions and compare them with prohibited requirements.

In another embodiment, the prohibitions of certain transactions may be tracked and represented as a high-dimensional risk array.

A high-dimensional risk array may represent the transaction/contract and one or more variables and dimensions. Colors may be mapped to risk level or “level of infraction” (red, yellow, green, etc), or goodness/favorableness level, and this mapping may be set by a user or a third party. A degree of risk involved in the transaction will be stored and may related to the transaction and other contextual factors such as a location, the transacting parties (i.e. if they have a track record of unethical or unfair transactions, etc.), types of transactions, commodities/assets associated with transactions, credit scores, or financial histories of the transaction parties, etc. A multi-dimensional risk array may be updated in real time when new transaction and data is parsed, computed or altered. The multidimensional risk array may indicate the degree to which a transaction or contract is at risk of noncompliance.

In instances where a transaction or contract has values or magnitudes of higher dimensional vectors exceeding a certain threshold at a particular time or place, etc., this may be visualized to a relevant user (e.g., financier, transacting parties, etc.) through some visualization, or a series of ameliorating steps can be recommended to neutralize the factors increasing the risk of the transaction or contract. Based on detected or predicted risk or concern level, the system may provide warnings on a GUI of a requestor or originator, where the warnings may be in a form of changing the color of the GUI, vibrating a computing device, etc.

In instances where a risk-level of a transaction or contract is above a certain threshold, the system may trigger one or more of the above mentioned amelioration actions. The GUI can be configured to send alert, trigger and notify the relevant user of the transaction or contract, including taking actions or providing feedback to a user on the user computing device. In further embodiments, a system may display requirements, regulations, or constraints on a GUI or user computing device. A GUI may display a notification of a high-risk transaction or contract using the multi-dimensional risk array. The user is notified and can accept or take ameliorating actions. The system may also educate the user regarding a possible risk. The indications of risk may be used to mark an online calendar. Colored marks may denote an aspect of transactions made on a particular day or date. Clicking on a colored mark may provide more information to a user and may also enter pertinent information into a blockchain.

In an instance where a risk-level of a transaction or contract is above a certain threshold, this may trigger alerts or trigger graphical indicators. For example, the risk of an interest bearing transaction may turn a smart phone display red, but other risks may be green. A user may see an alert to indicate the magnitude of risk on some or several dimensions is high. The user can decide to provide further details to lower the risk level or use the information provided to remodel a transaction or contract.

The present application discloses a method for automatically generating and taking amelioration action (e.g., preventing of purchase, requiring a bank approval, a delaying of delivery, automatic forcing of an online attempted transaction to an online or in-store purchase, etc.) based on detected transactions or events. This may trigger automatic forcing of an online attempted purchase to an in-store purchase, if R is high. For example, a “dial” interface in a GUI may be provided to banks or law enforcement officers and prediction analysts so that they can “dial” back and forth through a window of time, regarding risks, activities or items, and geographic locations. It may be useful to know what activities or items and risks were common in certain regions during a certain time period of the day or week. This may be useful for gaining insight into trends and for other purposes during audit or compliance operations.

In another embodiment, the alerts can take different forms and modalities. For example, audio alerts, vibration (e.g., of phone or mouse), emails, etc. The degree of alert may depend on degree of non-compliance (and/or risk of not knowing compliance). In some embodiments, higher volume notifications or vibrations may be associated with higher risk transactions or contracts. Additionally, an input GUI may allow one or more users to specify a possible particular concerns or needs for adherence to one or more dimensions of compliance, and thus the alerts may be tailored (customized) for the one or more users. The GUI may be used to configure user-specified alerts that can then be used during blockchain transactions. In scenarios where the disclosed system identifies non-compliance relating to a specific concept, the system can automatically trigger the delivery of information for educational purposes for a user to enable them to understand the reason for the non-compliance of the transaction or contract and how to amend it to make it compliant. This may be delivered in a number of formats (e.g. audio, text, video) via a number of means (e.g., phone, desktop, VR headset, etc.).

In one embodiment, the system may trigger a virtual reality lesson (with avatars) to help the user learn about financing, how a transaction is noncompliant, and what correcting to ameliorating actions can be taken. Another embodiment may deliver this lesson via video or audio to a device or via audio calls or an SMS text message in non-internet enabled environments. One such example may include where virtual reality may be is delivered to a user for educational purposes.

In some embodiments, one or more active learning models may be employed by a disclosed system so that it is able to learn from the experiences of many users in different geographies and among different cohorts or groups. Geographies may include cities, countries, rural areas, and the like. Cohorts may include people with certain characteristics or conformity to different laws. In some embodiments, a weighted voting system may be used to weight the various variables used in making decisions that determines if an alert is to be provided or a transaction or contract is deemed compliant. Such inputs may include one or more of a history of possible problems, a risk value, or a location of users and various stakeholders, etc. Such weighted voting approaches may be characterized primarily by three aspects—the inputs, the weights, and the quota. The inputs are (I₁, I₂, . . . , I_{N}), where N denotes the total number of inputs. An inputs weight (w) is the number of “votes” associated with the input. A quota (q) is a minimum number of votes required to “pass a motion”, which in this case refers primarily to a decision made by the system to provide an alert or visualization to one or more users. An advisory module, with natural language processing, located on a smart phone, or the cloud, or elsewhere, may provide a graphical user interface and an alerting system (audio, visual, or tactile) related to information on one or more of: certifying financial instruments for their compliance with laws, verifying transactions for compliance with laws.

One or more features involving compliant financial contracts maybe stored in a blockchain. For example, the anchor for a growing block may be a particular business, a particular financial transaction, etc. As the contract may be altered through time, or assessment of risks may morph through time, these items may be added to the growing block. The rate of addition to the block may be increased if risk or a concern level is judged to be high (e.g., to have a more granular record when deemed useful), and the content added to the block may change based on risk level and other factors. Consider, for example, a mortgage transaction. Instead of lending a buyer money to purchase an item (in this case, the anchor for the blockchain block), a bank might buy the item itself from a seller and re-sell it to the buyer at a profit, while allowing the buyer to pay the bank in installments. However, the bank's profit cannot be made explicit and therefore there are no additional penalties for late payment. In order to protect itself against default, the bank may require strict collateral. Goods or land may be registered to the name of the buyer from the start of the transaction.

Banks may handle loans for vehicles (in or case, the anchor for the blockchain block) in a similar way (selling the vehicle at a higher-than market price to a debtor and then retain ownership of the vehicle until the loan is paid).

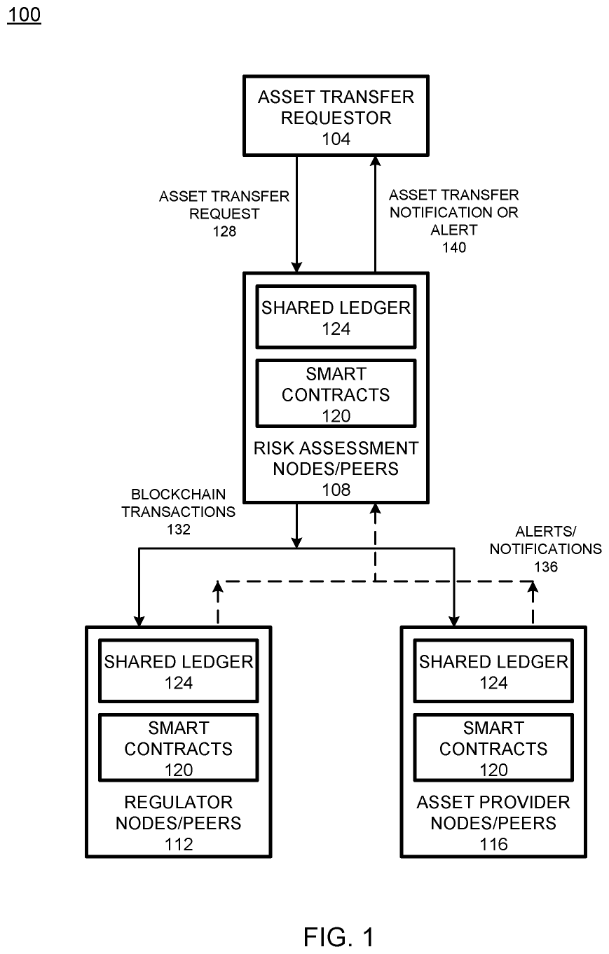

FIG. 1 illustrates a network diagram of a system including a database, according to example embodiments. Referring to FIG. 1, the network 100 includes an asset transfer requester 104. In one embodiment, the asset transfer requestor 104 is a blockchain node or peer within blockchain network 100. In another embodiment, asset transfer requestor 104 is a user device outside blockchain network 100.

The asset transfer requestor 104 provides an asset transfer request 128 to a risk assessment node or peer 108. The asset transfer request 128 includes one or more parameters related to a transaction to transfer a trade item or provide requested services to the asset transfer requestor 104. The parameters specify specific content and are described in more detail herein. The risk assessment node or peer 108 receives the asset transfer request 128 and produces a blockchain transaction 132 based on the request 128. Although a single risk assessment node/peer 108 is represented in FIG. 1, it should be understood there may be any number of risk assessment nodes/peers 108 in the blockchain network 100. In addition to processing the asset transfer requests 128 and initiating blockchain transactions 132, the risk assessment nodes/peers also provide asset transfer notifications or alerts 140 to the asset transfer requestor 104. The alerts or notifications 140 may be provided in the event of a completed/executed blockchain transaction 132, rejection or cancellation of a blockchain transaction 132, or an invitation for the asset transfer requestor 104 to provide a modified asset transfer request 128.

A regulator node/peer 112 receives the blockchain transactions 132 and verifies the blockchain transactions 132 include proper content. Alerts or notifications may be provided to the risk assessment nodes/peers 108 and/or asset provider nodes/peers 116 in the event of a completed/executed blockchain transaction 132, rejection or cancellation of a blockchain transaction 132, or an invitation for the asset transfer requestor 104 to provide a modified asset transfer request 128. Although a single regulator node/peer 112 is represented in FIG. 1, it should be understood there may be any number of regulator nodes/peers 112 in the blockchain network 100.

An asset provider nodes/peer 116 receives the blockchain transactions 132 and allocates the requested trade item or service (i.e. asset) to the asset transfer requestor 104. Alerts or notifications may be provided to the risk assessment nodes/peers 108 and/or regulator nodes/peers 112 in the event of a completed/executed blockchain transaction 132, rejection or cancellation of a blockchain transaction 132, or an invitation for the asset transfer requestor 104 to provide a modified asset transfer request 128. Although a single asset provider node/peer 116 is represented in FIG. 1, it should be understood there may be any number of asset provider nodes/peers 116 in the blockchain network 100.

Each of the risk assessment nodes peers 108, regulator nodes/peers 112, and asset provider nodes/peers 116 includes a shared ledger 124 and one or more smart contracts 120. Smart contracts 120 may apply specifically to blockchain transactions 132, and different smart contracts 120 may apply to transfers applying to different forms of assets such as financial transactions, services, or trade items.

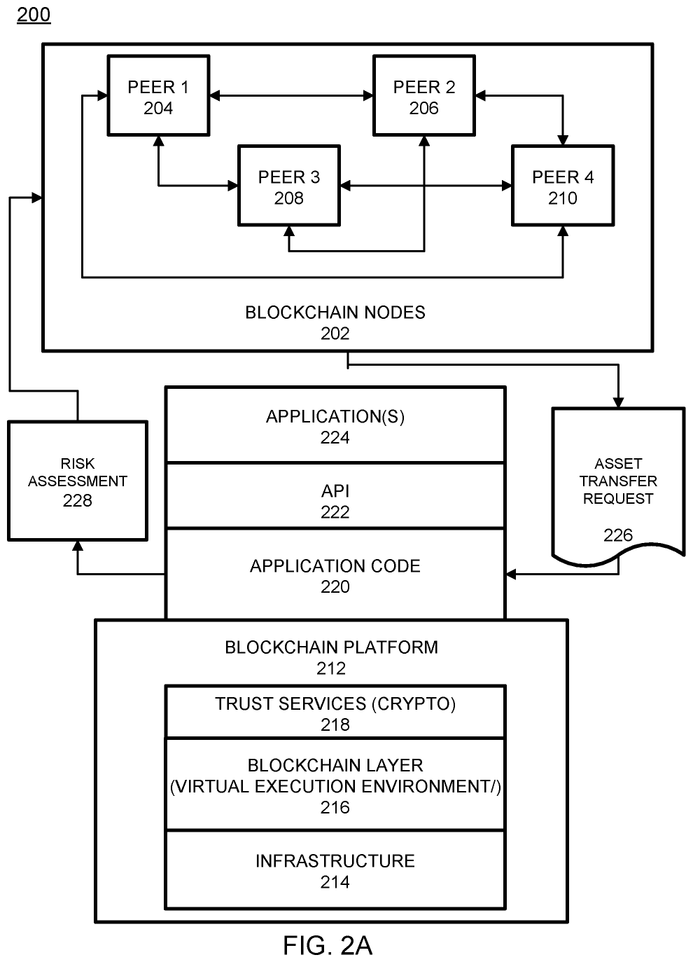

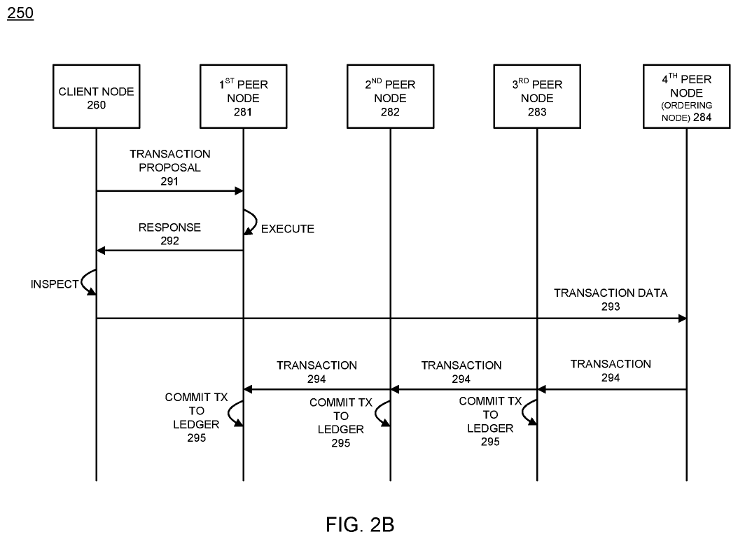

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the asset transfer request 226 from an asset transfer requestor may be processed by one or more processing entities (e.g., virtual machines) included in the blockchain layer 216. The result 228 may include a risk assessment based on a comparison between information and parameters within the asset transfer request 226 and various rules stored in one or more smart contracts. The physical infrastructure 214 may be utilized to retrieve any of the data or information described herein.

Within chaincode, a smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details. In FIG. 2A, one function may be to convert asset transfer requests 226 into risk assessments 228, which may be provided to one or more of the nodes 204-210.

FIG. 2B illustrates an example of a transactional flow 250 between nodes of the blockchain in accordance with an example embodiment. Referring to FIG. 2B, the transaction flow may include a transaction proposal 291 sent by an application client node 260 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 2B, the client node 260 initiates the transaction 291 by constructing and sending a request to the peer node 281, which is an endorser. The client 260 may include an application leveraging a supported software development kit (SDK), such as NODE, JAVA, PYTHON, and the like, which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260 which parses the payload for the application to consume.

In response, the application of the client 260 inspects/verifies the endorsing peers signatures and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction and broadcasts the transaction proposal and response within a transaction message to the ordering node 284. The transaction may contain the read/write sets, the endorsing peers' signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

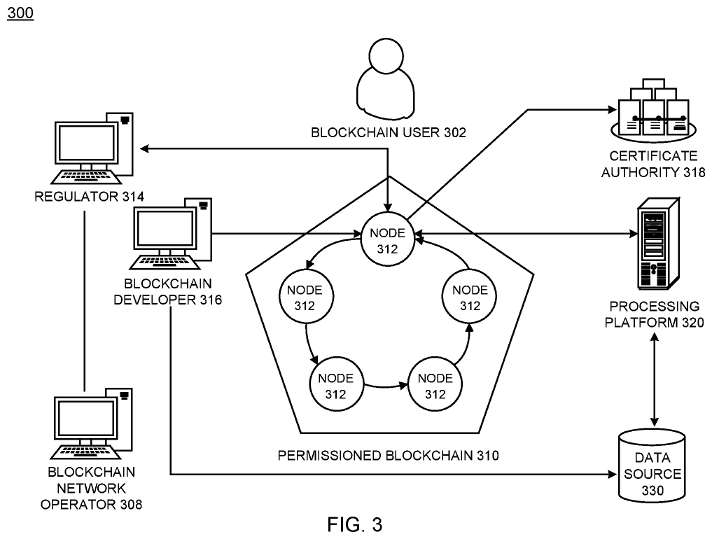

FIG. 3 illustrates an example of a permissioned blockchain network 300, which features a distributed, decentralized peer-to-peer architecture, and a certificate authority 318 managing user roles and permissions. In this example, the blockchain user 302 may submit a transaction to the permissioned blockchain network 310. In this example, the transaction can be a deploy, invoke, or query, and may be issued through a client-side application leveraging an SDK, directly through a REST API, or the like. Trusted business networks may provide access to regulator systems 314, such as auditors (the Securities and Exchange Commission in a U.S. equities market, for example). Meanwhile, a blockchain network operator system of nodes 308 manage member permissions, such as enrolling the regulator system 310 as an “auditor” and the blockchain user 302 as a “client”. An auditor could be restricted only to querying the ledger whereas a client could be authorized to deploy, invoke, and query certain types of chaincode.

A blockchain developer system 316 writes chaincode and client-side applications. The blockchain developer system 316 can deploy chaincode directly to the network through a REST interface. To include credentials from a traditional data source 330 in chaincode, the developer system 316 could use an out-of-band connection to access the data. In this example, the blockchain user 302 connects to the network through a peer node 312. Before proceeding with any transactions, the peer node 312 retrieves the user's enrollment and transaction certificates from the certificate authority 318. In some cases, blockchain users must possess these digital certificates in order to transact on the permissioned blockchain network 310. Meanwhile, a user attempting to drive chaincode may be required to verify their credentials on the traditional data source 330. To confirm the user's authorization, chaincode can use an out-of-band connection to this data through a traditional processing platform 320.

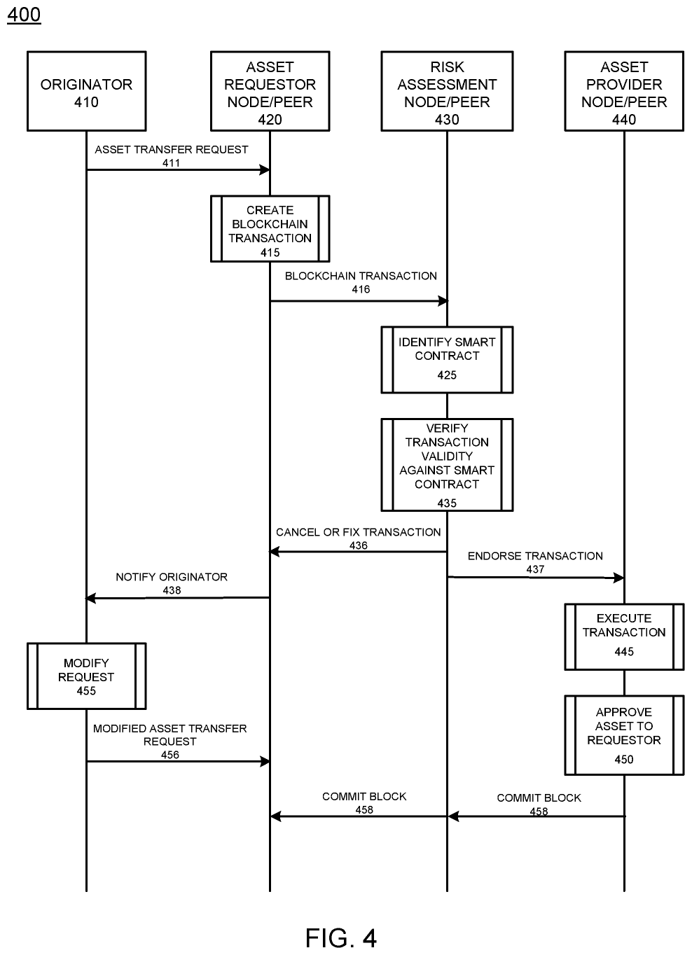

FIG. 4 illustrates a system messaging diagram for performing an asset transfer transaction, according to example embodiments. Referring to FIG. 4, the system diagram 400 includes an originator 410, one or more asset requestor nodes or peers 420, one or more risk assessment nodes or peers 430, and one or more asset provider nodes or peers 440. In one embodiment, the originator 410 is the same as the asset requester node/peer 420.

The originator 410 provides an asset transfer request 411 to the asset requester nodes/peers 420. The asset requester node/peer 420 obtains parameters from the asset transfer request 411 specifying conditions for transferring an asset. From these parameters, the asset requestor node/peer 420 creates a blockchain transaction 415 and transfers the blockchain transaction 416 to one or more risk assessment nodes/peers 430. The risk assessment nodes/peers 430 identify a smart contract 425 from the blockchain transaction 416. In one embodiment, the smart contract is identified based on a smart contract identifier provided as part of the blockchain transaction 416. In another embodiment, the smart contract is identified from one or more parameters specified in the blockchain transaction 416, which may provide clues as to a context (which may include a location), the nature of an asset transfer, a history of similar asset transfers (perhaps obtained from the shared ledger 124), or other information.

The risk assessment node or peer 430 then verifies validity of the transaction against the selected smart contract 435. The parameters in the blockchain transaction 416 are compared to rules contained within the identified smart contract, and a risk score is calculated. The risk score is higher when risk is greater, that is, when the differences between the parameters from the blockchain transaction 416 are high when compared to the rules specified in the identified smart contract. The risk score is lower when risk is lower, that is, when the differences between the parameters from the blockchain transaction 416 are low when compared to the rules specified in the identified smart contract.

If the calculated risk score is greater than a predetermined threshold, the risk assessment node/peer 430 provides a cancel or fix transaction notification 436 to the asset requestor node or peer 420, which in turn provides a notify originator notification 438 to the originator 410. If the calculated risk score is less than the predetermined threshold, the risk assessment node/peer 430 provides an endorsed transaction notification 437 to the asset provider node or peer 440.

In one embodiment, the risk assessment node/peer 430 may request an approval from a designated party associated with the originator 410 and execute the blockchain transaction in response to the approval by the designated party. The one or more designated parties may be specified in a smart contract. Furthermore, by the smart contract, a designated party may be configured to approve one or more parameters. For example, at a transaction time (i.e. a request to transfer an asset), the requestor/originator 410 may indicate, on a graphical user interface (GUI), a desired one or more designated parties. The system then requests an approval from the desired one or more designated parties associated with the requestor/originator 410 and executes the blockchain transaction in response to the approval by the one or more desired designated parties. Therefore, in addition to other verification/checking, the smart contract may also be used to verify the eligibility of each indicated desired designated party to approve an approval request.

In the event of a cancelled transaction or a request to fix the transaction 436, the originator 410 creates a modified request 455 including one or more different parameters than specified in the original asset transfer request 411. The originator 410 then provides the modified asset transfer request 456 to the asset requestor node/peer 420 and the process resumes as described earlier in steps 415-435.

In the event of an endorsed transaction 437, the asset provider nodes/peers 440 execute the transaction 445, and approves the asset transfer to the requestor 450. The results of the executed transaction 445 are included in a new block 458 that is committed to the blockchain. The process then repeats with an originator 410 submitting a new asset transfer request 411 or modified asset transfer request 456.

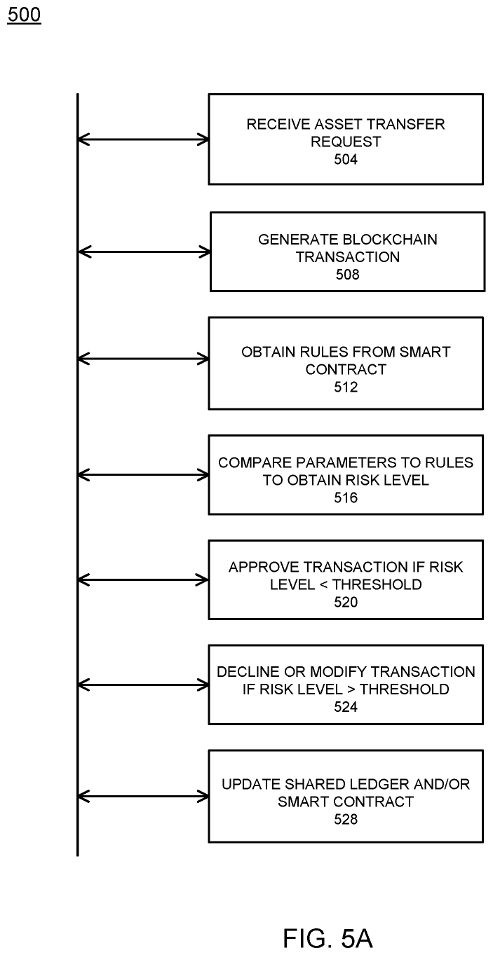

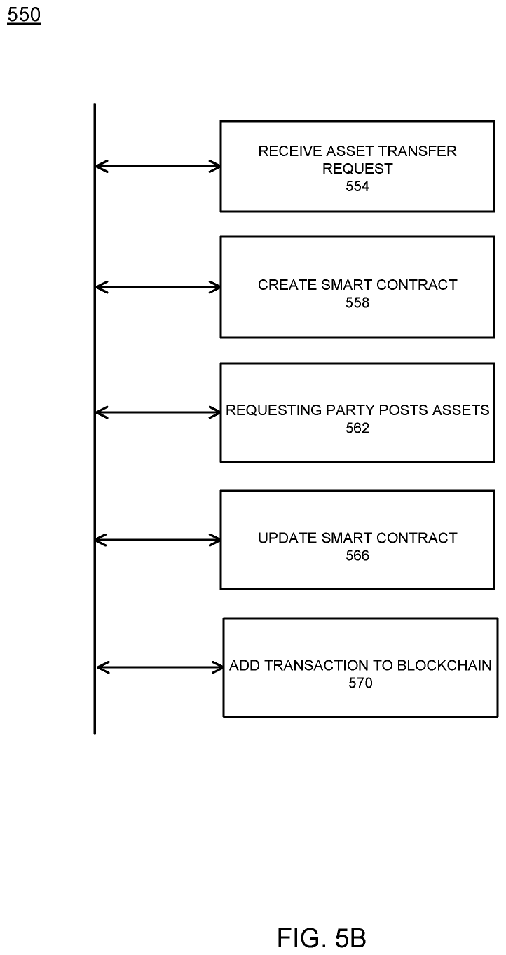

FIG. 5A illustrates a flow diagram 500 for performing an asset transfer transaction, according to example embodiments. Referring to FIG. 5A, the method 500 may include one or more of the following steps.

At block 504, an asset transfer request is received. The asset transfer request includes one or more parameters corresponding to aspects of an asset transfer transaction. In some embodiments, the asset transfer request specifies a specific smart contract.

At block 508, a blockchain transaction is generated from the asset transfer request. The blockchain transaction includes the one or more parameters, and specifies a smart contract. In one embodiment, the smart contract is identified from the parameters, from a plurality of smart contracts.

At block 512, rules are obtained from the identified smart contract. Some rules may specify an exact parameter value that must be met. Other rules may specify a parameter value that is not to be exceeded. Other rules may specify a minimum parameter value. Yet other rules may specify one or more ranges of parameter values that must be met.

At block 516, parameters specified in the blockchain transaction are compared to rules specified in the identified smart contract to obtain a risk level. In one embodiment, the risk level is derived from a numerical score based on all of the comparisons. In another embodiment, the risk level is itself a numerical score based on all of the comparisons.

At block 520, the blockchain transaction is approved if the risk level is less than a predetermined threshold. The predetermined threshold reflects a maximum allowed variance between the parameters specified in the asset transfer request and the identified smart contract. The threshold reflects a maximum amount of variance in blockchain transactions.

At block 524, the blockchain transaction is declined if the risk level is greater than the predetermined threshold. The predetermined threshold reflects a maximum allowed variance between the parameters specified in the asset transfer request and the identified smart contract. The threshold reflects a maximum amount of variance in blockchain transactions.

At block 528, the shared ledger and/or smart contract is updated to reflect an approved transaction, a declined transaction, a modified transaction, or modified rules in the smart contract.

FIG. 5B illustrates a flow diagram 550 of a method of managing a smart contract in a blockchain, according to example embodiments. The method may include one or more of the following steps.

At block 554, an asset transfer request is received. The system receives a request from a borrowing party (e.g., through an interface provided on a device associated with the borrowing party). For example, the request may be a request to secure a loan or a line of credit in exchange for providing an asset, such as a digital asset or non-digital asset, as collateral. The request may be accompanied by the borrowing party's acceptance of one or more terms associated with a specific loan, as advertised by a lending party. The system sends the received request of the borrowing party to the lending party for approval. The system may display a message on a lending party's user device to request an approval of the borrowing party. The system then receives a confirmation from the lending party. In one example the roles of the borrowing party and the lending party on the system may switch in that the borrowing party may advertise its desire to secure a loan (accompanied by one or more terms/conditions) and a lending party may select the borrowing party to lend to. The system then sends the request to the borrowing party for acceptance and receives a confirmation from the borrowing party. Various algorithms and data analysis terms could also be chosen by the party such that, for example, a value history of the cryptocurrency going back 6 months could be included in determining whether to ask for more or return cryptocurrency according to the terms of the smart contract.

At block 558, a smart contract is created on a blockchain network. In an example, the system populates a generic (empty) smart contract with specific terms, agreed upon by the lending and borrowing parties, to generate a smart contract that is then implemented on the blockchain network. The system then generates a secure token for the smart contract according to any know or to be developed method of generating tokens as it relates to operation of digital currencies and assets. The token is a string of characters that identifies a proper participant in the process or identifies their digital wallet. A token can be considered a key that enables entries on the blockchain network or to confirm that the party proffering the token has the right to sign the contract, receive funds, distribute funds, or perform some function associated with the smart contract.

At block 562, the requesting party posts assets. The system sends a request to the borrowing party to post one or more assets to an asset address as collateral (e.g., one or more bitcoins to Bitcoin addresses). Concurrent with the posting of one or more bitcoins, the borrowing party also creates a unique password (first unique password) to the bitcoin addresses. In one aspect, the creation of the loan requires a bitcoin address to be created with three keys mandated to be created by three unique parties, the borrower, the lender, and a third party which may be an oracle. The system then receives the posted bitcoin(s) (and the first unique password) and sends a request to the lending party to accept the bitcoin(s) as collateral. Upon acceptance, the lending party also creates another unique password (second unique password) in association with the accepted collateral. The system receives the lending party's acceptance and the second unique password (the second of three keys). The oracle may be notified to generate its unique password (the third of the three keys). All the confirmed loan agreement details can be embedded into the specific open fields of the smart contract in the assigned token.

At block 566, the smart contract is updated. The system populates the smart contract with the secure token, the first unique password, the second unique password and the third unique password. Accordingly, the system yields/generates a secure smart contract. Thereafter, the system and/or the blockchain network creates a unique hash for the secure smart contract and timestamps the same. The system network could also generate a timestamp and then hash the timestamp with a hash function to generate a hash code or hash value that is then included within the smart contract. From the hash value, the timestamp data can be retrieved. In a sense this provides a notarization of an original copy of the contract.

At block 570, a transaction is added to the blockchain. The system and/or the blockchain network inserts the time-stamped hash into a blockchain such as a bitcoin blockchain. The process of inserting the time-stamped hash into the blockchain can occur either by the system or by the blockchain network. Thereafter, the process will be repeated as described above. In one aspect, the system includes a smart contract creator that is configured to receive the data associated with creating the smart contract. The smart contract creator can be configured to: receive a request from a first party, the request having a parameter associated with a contractual relationship, receive a confirmation from a second party including an acceptance of the parameter by the second party and create the smart contract on a blockchain network based on the confirmation, the parameter and the contractual relationship. This can be performed by generated the necessary data for operation of the smart contract and deploying the smart contract on the blockchain network via an instruction. A smart contract monitor can be configured to monitor an execution of the smart contract and a current value of an asset associated with the smart contract to yield a status. The value of the asset can be received by an oracle at the smart contract monitor which can perform its programmed functions based on the received data. A smart contract manager can be configured within the system or the blockchain network to manage the smart contract based on the status. These various components can be computer-implemented and programmed in any programming language that is convenient to carry out the respective instructions.

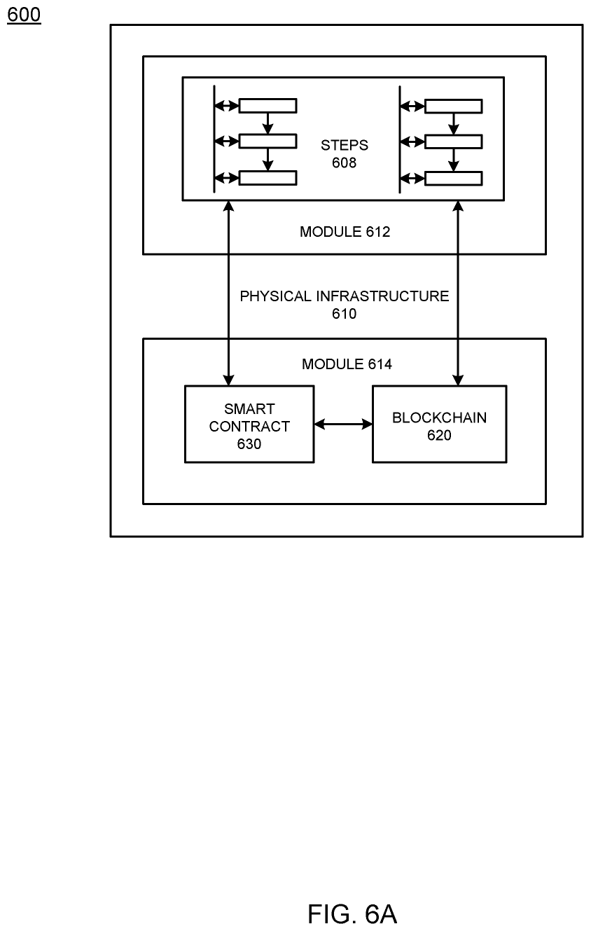

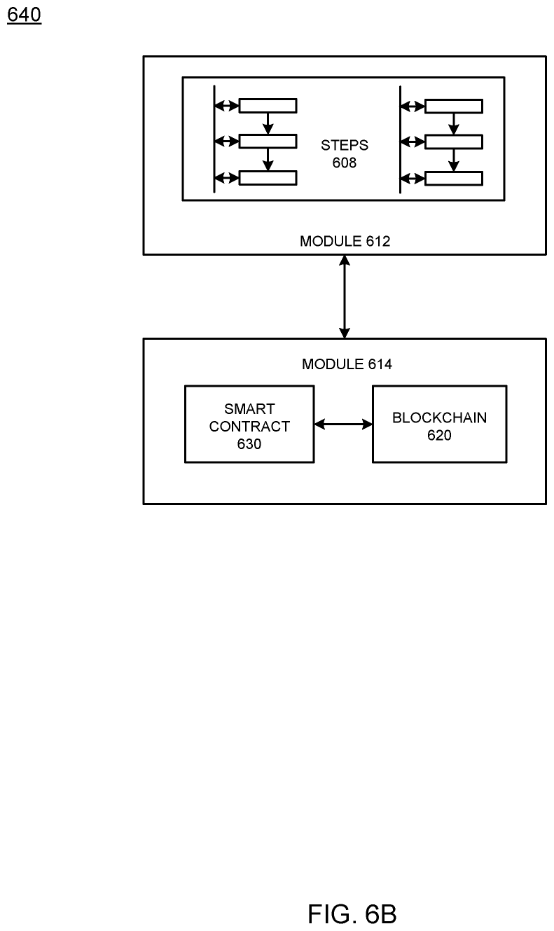

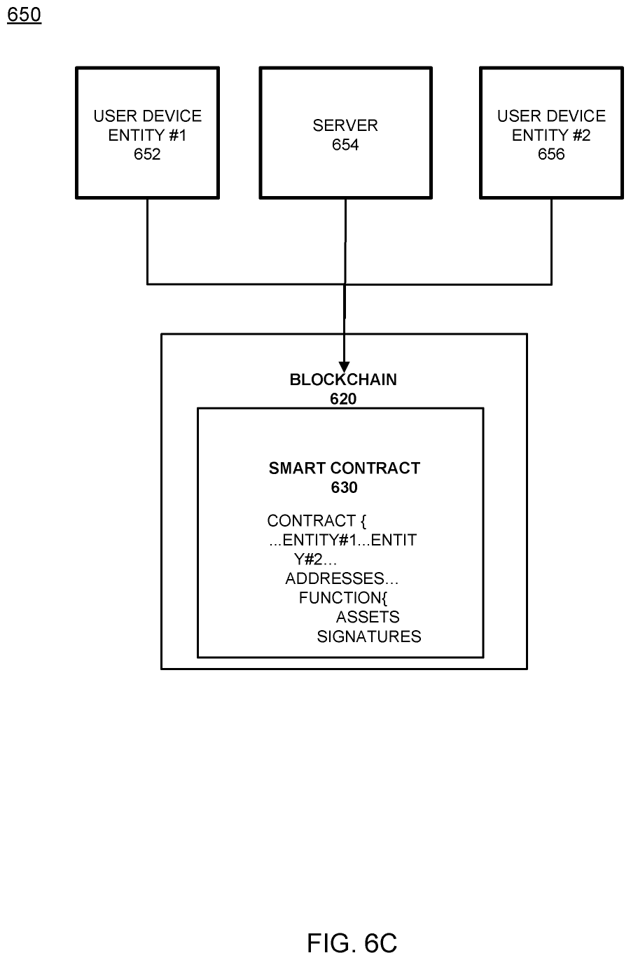

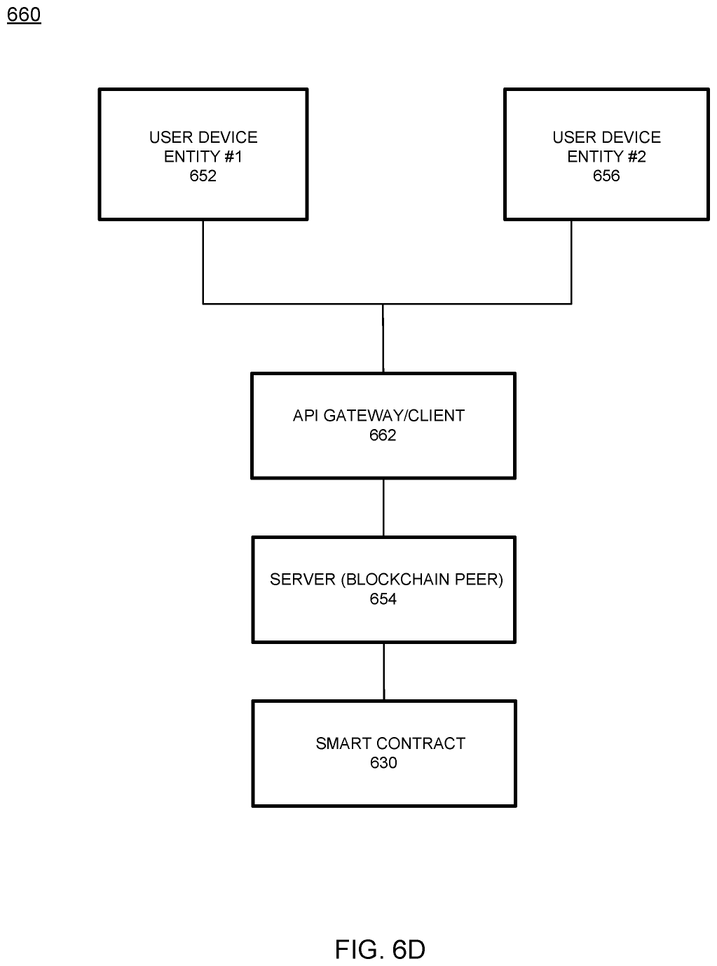

FIG. 6A illustrates an example system 600 that includes a physical infrastructure 610 configured to perform various operations according to example embodiments. Referring to FIG. 6A, the physical infrastructure 610 includes a module 612 and a module 614. The module 614 includes a blockchain 620 and a smart contract 630 (which may reside on the blockchain 620), that may execute any of the operational steps 608 (in module 612) included in any of the example embodiments. The steps/operations 608 may include one or more of the embodiments described or depicted and may represent output or written information that is written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6B illustrates an example system 640 configured to perform various operations according to example embodiments. Referring to FIG. 6B, the system 640 includes a module 612 and a module 614. The module 614 includes a blockchain 620 and a smart contract 630 (which may reside on the blockchain 620), that may execute any of the operational steps 608 (in module 612) included in any of the example embodiments. The steps/operations 608 may include one or more of the embodiments described or depicted and may represent output or written information that is written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6C illustrates an example smart contract configuration among contracting parties and a mediating server configured to enforce the smart contract terms on the blockchain according to example embodiments. Referring to FIG. 6C, the configuration 650 may represent a communication session, an asset transfer session or a process or procedure that is driven by a smart contract 630 which explicitly identifies one or more user devices 652 and/or 656. The execution, operations and results of the smart contract execution may be managed by a server 654. Content of the smart contract 630 may require digital signatures by one or more of the entities 652 and 656 which are parties to the smart contract transaction. The results of the smart contract execution may be written to a blockchain 620 as a blockchain transaction. The smart contract 630 resides on the blockchain 620 which may reside on one or more computers, servers, processors, memories, and/or wireless communication devices.

FIG. 6D illustrates a system 660 including a blockchain, according to example embodiments. Referring to the example of FIG. 6D, an application programming interface (API) gateway 662 provides a common interface for accessing blockchain logic (e.g., smart contract 630 or other chaincode) and data (e.g., distributed ledger, etc.). In this example, the API gateway 662 is a common interface for performing transactions (invoke, queries, etc.) on the blockchain by connecting one or more entities 652 and 656 to a blockchain peer (i.e., server 654). Here, the server 654 is a blockchain network peer component that holds a copy of the world state and a distributed ledger allowing clients 652 and 656 to query data on the world state as well as submit transactions into the blockchain network where, depending on the smart contract 630 and endorsement policy, endorsing peers will run the smart contracts 630.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

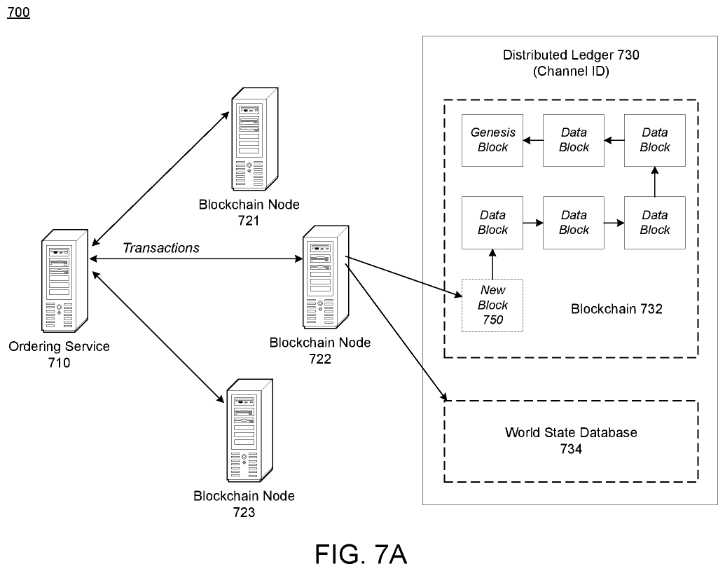

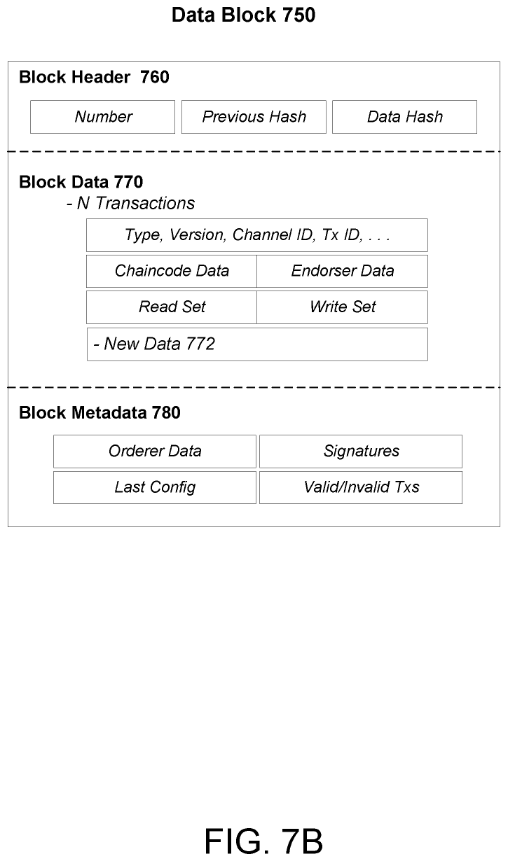

FIG. 7A illustrates a process 700 of a new block being added to a distributed ledger 730, according to example embodiments, and FIG. 7B illustrates contents of a block structure 750 for blockchain, according to example embodiments. Referring to FIG. 7A, clients (not shown) may submit transactions to blockchain nodes 721, 722, and/or 723. Clients may be instructions received from any source to enact activity on the blockchain 730. As an example, clients may be applications that act on behalf of a requester, such as a device, person or entity to propose transactions for the blockchain. The plurality of blockchain peers (e.g., blockchain nodes 721, 722, and 723) may maintain a state of the blockchain network and a copy of the distributed ledger 730. Different types of blockchain nodes/peers may be present in the blockchain network including endorsing peers which simulate and endorse transactions proposed by clients and committing peers which verify endorsements, validate transactions, and commit transactions to the distributed ledger 730. In this example, the blockchain nodes 721, 722, and 723 may perform the role of endorser node, committer node, or both.

The distributed ledger 730 includes a blockchain 732 which stores immutable, sequenced records in blocks, and a state database 734 (current world state) maintaining a current state of the blockchain 732. One distributed ledger 730 may exist per channel and each peer maintains its own copy of the distributed ledger 730 for each channel of which they are a member. The blockchain 732 is a transaction log, structured as hash-linked blocks where each block contains a sequence of N transactions. Blocks may include various components such as shown in FIG. 7B. The linking of the blocks (shown by arrows in FIG. 7A) may be generated by adding a hash of a prior block's header within a block header of a current block. In this way, all transactions on the blockchain 732 are sequenced and cryptographically linked together preventing tampering with blockchain data without breaking the hash links. Furthermore, because of the links, the latest block in the blockchain 732 represents every transaction that has come before it. The blockchain 732 may be stored on a peer file system (local or attached storage), which supports an append-only blockchain workload.

The current state of the blockchain 732 and the distributed ledger 732 may be stored in the state database 734. Here, the current state data represents the latest values for all keys ever included in the chain transaction log of the blockchain 732. Chaincode invocations execute transactions against the current state in the state database 734. To make these chaincode interactions extremely efficient, the latest values of all keys are stored in the state database 734. The state database 734 may include an indexed view into the transaction log of the blockchain 732, it can therefore be regenerated from the chain at any time. The state database 734 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing nodes creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction”. Different channels may have different endorsement policies. Endorsed transactions are forward by the client application to ordering service 710.

The ordering service 710 accepts endorsed transactions, orders them into a block, and delivers the blocks to the committing peers. For example, the ordering service 710 may initiate a new block when a threshold of transactions has been reached, a timer times out, or another condition. In the example of FIG. 7A, blockchain node 722 is a committing peer that has received a new data block 750 for storage on blockchain 730.

The ordering service 710 may be made up of a cluster of orderers. The ordering service 710 does not process transactions, smart contracts, or maintain the shared ledger. Rather, the ordering service 710 may accept the endorsed transactions and specifies the order in which those transactions are committed to the distributed ledger 730. The architecture of the blockchain network may be designed such that the specific implementation of ‘ordering’ (e.g., Solo, Kafka, BFT, etc.) becomes a pluggable component.

Transactions are written to the distributed ledger 730 in a consistent order. The order of transactions is established to ensure that the updates to the state database 734 are valid when they are committed to the network. Unlike a cryptocurrency blockchain system (e.g., Bitcoin, etc.) where ordering occurs through the solving of a cryptographic puzzle, or mining, in this example the parties of the distributed ledger 730 may choose the ordering mechanism that best suits that network.

When the ordering service 710 initializes a new block 750, the new block 750 may be broadcast to committing peers (e.g., blockchain nodes 721, 722, and 723). In response, each committing peer validates the transaction within the new block 750 by checking to make sure that the read set and the write set still match the current world state in the state database 734. Specifically, the committing peer can determine whether the read data that existed when the endorsers simulated the transaction is identical to the current world state in the state database 734. When the committing peer validates the transaction, the transaction is written to the blockchain 732 on the distributed ledger 730, and the state database 734 is updated with the write data from the read-write set. If a transaction fails, that is, if the committing peer finds that the read-write set does not match the current world state in the state database 734, the transaction ordered into a block will still be included in that block, but it will be marked as invalid, and the state database 734 will not be updated.

Referring to FIG. 7B, a block 750 (also referred to as a data block) that is stored on the blockchain 732 of the distributed ledger 730 may include multiple data segments such as a block header 760, block data 770, and block metadata 780. It should be appreciated that the various depicted blocks and their contents, such as block 750 and its contents. shown in FIG. 7B are merely for purposes of example and are not meant to limit the scope of the example embodiments. In some cases, both the block header 760 and the block metadata 780 may be smaller than the block data 770 which stores transaction data, however this is not a requirement. The block 750 may store transactional information of N transactions (e.g., 100, 500, 1000, 2000, 3000, etc.) within the block data 770. The block 750 may also include a link to a previous block (e.g., on the blockchain 732 in FIG. 7A) within the block header 760. In particular, the block header 760 may include a hash of a previous block's header. The block header 760 may also include a unique block number, a hash of the block data 770 of the current block 750, and the like. The block number of the block 750 may be unique and assigned in an incremental/sequential order starting from zero. The first block in the blockchain may be referred to as a genesis block which includes information about the blockchain, its members, the data stored therein, etc.

The block data 770 may store transactional information of each transaction that is recorded within the block 750. For example, the transaction data may include one or more of a type of the transaction, a version, a timestamp, a channel ID of the distributed ledger 730, a transaction ID, an epoch, a payload visibility, a chaincode path (deploy tx), a chaincode name, a chaincode version, input (chaincode and functions), a client (creator) identify such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, one or more parameters or rules, a smart contract identifier, a predetermined risk level threshold, an approval or modification status for a transaction, and the like. The transaction data may be stored for each of the N transactions.

In some embodiments, the block data 770 may also store data 772 which adds additional information to the hash-linked chain of blocks in the blockchain 732. Accordingly, the data 772 can be stored in an immutable log of blocks on the distributed ledger 730. Some of the benefits of storing such data 772 are reflected in the various embodiments disclosed and depicted herein.

The block metadata 780 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 710. Meanwhile, a committer of the block (such as blockchain node 722) may add validity/invalidity information based on an endorsement policy, verification of read/write sets, and the like. The transaction filter may include a byte array of a size equal to the number of transactions in the block data 770 and a validation code identifying whether a transaction was valid/invalid.

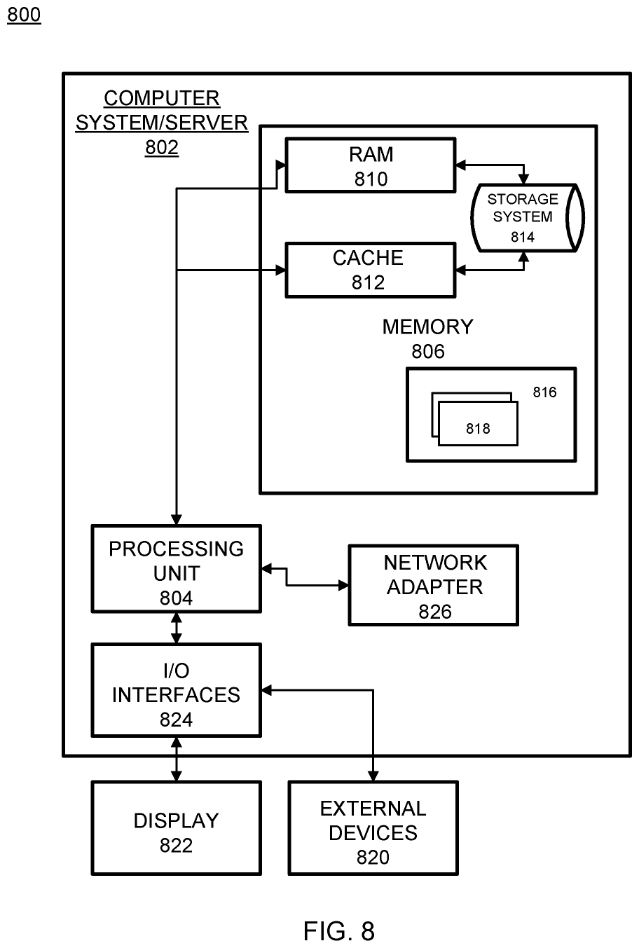

FIG. 8 is not intended to suggest any limitation as to the scope of use or functionality of embodiments of the application described herein. Regardless, the computing node 800 is capable of being implemented and/or performing any of the functionality set forth hereinabove.

In computing node 800 there is a computer system/server 802, which is operational with numerous other general purpose or special purpose computing system environments or configurations. Examples of well-known computing systems, environments, and/or configurations that may be suitable for use with computer system/server 802 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 802 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 802 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 802 in cloud computing node 800 is shown in the form of a general-purpose computing device. The components of computer system/server 802 may include, but are not limited to, one or more processors or processing units 804, a system memory 806, and a bus that couples various system components including system memory 806 to processor 804.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 802 typically includes a variety of computer system readable media. Such media may be any available media that is accessible by computer system/server 802, and it includes both volatile and non-volatile media, removable and non-removable media. System memory 806, in one embodiment, implements the flow diagrams of the other figures. The system memory 806 can include computer system readable media in the form of volatile memory, such as random-access memory (RAM) 810 and/or cache memory 812. Computer system/server 802 may further include other removable/non-removable, volatile/non-volatile computer system storage media. By way of example only, storage system 814 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 806 may include at least one program product having a set (e.g., at least one) of program modules that are configured to carry out the functions of various embodiments of the application.

Program/utility 816, having a set (at least one) of program modules 818, may be stored in memory 806 by way of example, and not limitation, as well as an operating system, one or more application programs, other program modules, and program data. Each of the operating system, one or more application programs, other program modules, and program data or some combination thereof, may include an implementation of a networking environment. Program modules 818 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 802 may also communicate with one or more external devices 820 such as a keyboard, a pointing device, a display 822, etc.; one or more devices that enable a user to interact with computer system/server 802; and/or any devices (e.g., network card, modem, etc.) that enable computer system/server 802 to communicate with one or more other computing devices. Such communication can occur via I/O interfaces 824. Still yet, computer system/server 802 can communicate with one or more networks such as a local area network (LAN), a general wide area network (WAN), and/or a public network (e.g., the Internet) via network adapter 826. As depicted, network adapter 826 communicates with the other components of computer system/server 802 via a bus. It should be understood that although not shown, other hardware and/or software components could be used in conjunction with computer system/server 802. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit including custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A system, comprising:
a blockchain network, comprising:
a first blockchain node, configured to:
receive a request to transfer an asset, the request comprising a smart contract identifier and one or more parameters, the asset comprising one of a trade item or a service to be performed;
generate a blockchain transaction comprising the smart contract identifier and the one or more parameters; and
a second blockchain node, configured to:
obtain one or more rules from a smart contract that corresponds to the smart contract identifier;
compare the one or more parameters to the one or more rules to obtain a risk level;
in response to the risk level is greater than a threshold, the second blockchain node configured to not execute the blockchain transaction; and
in response to the risk level is not greater than the threshold, the second blockchain node is configured to execute the transaction.

2. The system of claim 1, wherein the one or more second rules specifies conditions to transfer the asset, the conditions comprising one or more of an interest rate, a cost, a time period, a context, and a loan amount, wherein agreement between the one or more parameters and one or more rules decreases the risk level, wherein disagreement between the one or more parameters and one or more rules increases the risk level.

3. The system of claim 1, wherein the second blockchain node configured to not execute the blockchain transaction comprises one or more of the second blockchain node:
cancels the blockchain transaction;
provides a notification to an originator of the request that the blockchain transaction was not executed, the notification comprising an identification of one or more rules not satisfied by the request;
requests an approval from a designated party associated with the requestor and executes the blockchain transaction in response to the approval by the designated party; and
processes a modified request from the originator and executes a blockchain transaction that corresponds to the modified request, in response to the modified request produces a risk level lower than the threshold.

4. The system of claim 3, wherein the notification further comprises advisory or educational content directed to the originator in accordance with to one or more of the rules and an originator profile.

5. The system of claim 3, wherein the second blockchain node configured to not execute the blockchain transaction comprises the second blockchain node provides a multi-dimensional graphical risk representation to a device associated with the originator, the risk representation identifies a level of match between the one or more parameters and the one or more rules.

6. The system of claim 1, wherein the second blockchain node updates a database with one or more of prohibited assets and prohibited transactions based on one or more of risk levels, one or more rules, a context that corresponds to the request, parties involved in the asset transfer request, a transaction type, and a financial score or financial history associated with one or more of the parties.

7. The system of claim 1, wherein the request does not specify the smart contract identifier, wherein the second blockchain node determines, based on the one or more of the one or more parameters, a context, and one or more previous transactions, the smart contract from a plurality of smart contracts and obtains the one or more rules from the smart contract determined from the one or more parameters.

8. A method, comprising:
receiving, by a blockchain node, a request to transfer an asset, the request comprising a smart contract identifier and one or more parameters, the asset comprising one of a trade item or a service to be performed;
generating a blockchain transaction comprising the smart contract identifier and the one or more parameters;
obtaining one or more rules from a smart contract corresponding to the smart contract identifier;
comparing the one or more parameters to the one or more rules to obtain a risk level;
in response to the risk level being greater than a threshold:
not executing the blockchain transaction; and
in response to the risk level not being greater than the threshold:
executing the transaction.

9. The method of claim 8, wherein the one or more second rules specify conditions for transferring the asset, the conditions comprising one or more of an interest rate, a cost, a time period, a context, and a loan amount, wherein agreement between the one or more parameters and one or more rules decreases the risk level, wherein disagreement between the one or more parameters and one or more rules increases the risk level.

10. The method of claim 8, wherein not executing the blockchain transaction comprises one or more of:
cancelling the blockchain transaction;
providing a notification to an originator of the request that the blockchain transaction was not executed, the notification comprising an identification of one or more rules not satisfied by the request;
requesting an approval from a designated party associated with the requestor and executing the blockchain transaction in response to the approval by the designated party; and
processing a modified request from the originator and executing a blockchain transaction corresponding to the modified request, in response to the modified request producing a risk level lower than the threshold.

11. The method of claim 10, wherein the notification further comprising advisory or educational content directed to the originator according to one or more of the rules and an originator profile.

12. The method of claim 10, wherein not executing the blockchain transaction comprises:
providing a multi-dimensional graphical risk representation to a device associated with the originator, the risk representation identifying a level of match between the one or more parameters and the one or more rules.

13. The method of claim 8, further comprising:
updating a database with one or more of prohibited assets and prohibited transactions based on one or more of risk levels, one or more rules, a context corresponding to the request, parties involved in the asset transfer request, a transaction type, and a financial score or financial history associated with one or more of the parties.

14. The method of claim 8, wherein the request does not specify the smart contract identifier, wherein the method further comprising:
determining, based on the one or more of the one or more parameters, a context, and one or more previous transactions, the smart contract from a plurality of smart contracts; and
obtaining the one or more rules from the smart contract determined from the one or more parameters.

15. A non-transitory computer readable medium comprising instructions, that when read by a processor, cause the processor to perform:
receiving, by a blockchain node, a request to transfer an asset, the request comprising a smart contract identifier and one or more parameters, the asset comprising one of a trade item or a service to be performed;
generating a blockchain transaction comprising the smart contract identifier and the one or more parameters;
obtaining one or more rules from a smart contract corresponding to the smart contract identifier;
comparing the one or more parameters to the one or more rules to obtain a risk level;
in response to the risk level being greater than a threshold:
not executing the blockchain transaction; and
in response to the risk level not being greater than the threshold:
executing the transaction.

16. The non-transitory computer-readable medium of claim 15, wherein the one or more second rules specify conditions for transferring the asset, the conditions comprising one or more of an interest rate, a cost, a time period, a context, and a loan amount, wherein agreement between the one or more parameters and one or more rules decreases the risk level, wherein disagreement between the one or more parameters and one or more rules increases the risk level.

17. The non-transitory computer-readable medium of claim 15, wherein not executing the blockchain transaction comprises one or more of:
cancelling the blockchain transaction;
providing a notification to an originator of the request that the blockchain transaction was not executed, the notification comprising an identification of one or more rules not satisfied by the request;
requesting an approval from a designated party associated with the requestor and executing the blockchain transaction in response to the approval by the designated party; and
processing a modified request from the originator and executing a blockchain transaction corresponding to the modified request, in response to the modified request producing a risk level lower than the threshold.

18. The non-transitory computer-readable medium of claim 17, wherein the notification further comprising advisory or educational content directed to the originator according to one or more of the rules and an originator profile, wherein not executing the blockchain transaction comprises providing a multi-dimensional graphical risk representation to a device associated with the originator, the risk representation identifying a level of match between the one or more parameters and the one or more rules.

19. The non-transitory computer-readable medium of claim 15, further comprising:
updating a database with one or more of prohibited assets and prohibited transactions based on one or more of risk levels, one or more rules, a context corresponding to the request, parties involved in the asset transfer request, a transaction type, and a financial score or financial history associated with one or more of the parties.

20. The non-transitory computer-readable medium of claim 15, wherein the request does not specify the smart contract identifier, wherein the method further comprising:
determining, based on the one or more of the one or more parameters, a context, and one or more previous transactions, the smart contract from a plurality of smart contracts; and
obtaining the one or more rules from the smart contract determined from the one or more parameters.
